(19) United States
(12) Patent Application Publication
(10) Pub. No.: US 2024/0349919 A1
(43) Pub. Date: Oct. 24, 2024

(54) ADAPTER RING FOR CONVERTING AN ORDINARY WATER BOTTLE INTO A SMART WATER BOTTLE

(71) Applicant: BonCor Medical, LLC, Bingham Farms, MI (US)

(72) Inventors: Peter L. Bono, Bingham Farms, MI (US); Michael R. Dupuie, II, Marysville, MI (US)

(21) Appl. No.: 18/641,250

(22) Filed: Apr. 19, 2024

Related U.S. Application Data
(60) Provisional application No. 63/497,490, filed on Apr. 21, 2023.

(51) Int. Cl. A47G 19/22; B65D 47/30; B65D 51/24; G01F 23/292

(52) U.S. Cl. CPC A47G 19/2227; B65D 47/305; B65D 51/242; G01F 23/292

(57) ABSTRACT

The present invention is directed to an adapter ring securable to a new or pre-existing water bottle that provides monitoring of the liquid inside of the water bottle and wireless communication to an external electronic device, which may include an algorithm to help the user maintain proper hydration. A bottom portion of the adapter ring includes external or internal helical threads, or the like, adapted to fit onto a threaded portion of the water bottle or container. A top portion of the adapter ring also includes threads, or the like, for connection to the original water bottle top. The adapter ring includes a sealed chamber having a wall separating the liquid flow path from the electronics so that the liquid flow path provides a fluid communication between the top portion and bottom portion of the adapter ring to allow for consumption of the liquid in the container.

### PRIORITY CLAIM

In accordance with 37 C.F.R. 1.76, a claim of priority is included in an Application Data Sheet filed concurrently herewith. Accordingly, the present invention claims priority to U.S. Provisional Patent Application No. 63/497,490, entitled “Wireless Container Lid for Measuring Liquid Volume Within a Container”, filed Apr. 21, 2023. The contents of the above referenced application are incorporated herein by reference in their entirety.

### FIELD OF THE INVENTION

The present invention relates to water bottles for personal hydration. More specifically, a water or liquid container lid adapter that includes a liquid level measuring sensor used to measure and indicate liquid volume in a portable liquid container that may wirelessly communicate with an electronic device having a hydration algorithm to facilitate a user's hydration.

### BACKGROUND

The Internet of Things (IoT) describes physical objects with sensors, processing ability, software and other technologies that connect and exchange data with other devices and systems over the Internet or other communications networks as “smart” devices. The rapid growth of the Internet of Things (IoT) and miniature wearable biosensors have generated new opportunities for personalized smart devices to improve the user's life by improving fitness as well as personal health.

Wearable devices, such as “smart” watches and bracelets can monitor a wearer's physical activities and health parameters. These “smart” wearable devices enable individualized monitoring to help wearers take action and control their health and fitness levels. These “smart” wearable devices can be further augmented by electronically tethering them to an external portable computing device for various ancillary computations and capabilities. The majority of these “smart” wearable devices require the person to have the device in contact with the user's skin; however, other “smart” devices that are separate from the person exist on the market and may help the person further monitor health, nutritional intake or hydration level.

Fluid intake is important to an individual's health and wellbeing. Dehydration, caused by a lack of proper hydration, can be a very serious issue and can lead to adverse complications, including confusion, falls, hospitalization, and even death. The under-consumption of water is a considerable health concern; especially for elderly individuals due to the degradation of regulatory mechanisms with age. Most people only drink liquids when they remember to drink; however, most people do not remember to drink until they are thirsty, and thirst usually presents itself only after person is at least partially dehydrated. Therefore, monitoring fluid intake is a useful way to determine if adequate fluid has been consumed. There has been a trend in recent years to develop tools to monitor fluid intake using “smart” devices, such as a “smart” bottle/container.

U.S. Pat. No. 10,188,230 discloses a container assembly comprising a container defining a cavity to hold a liquid; a liquid level sensor, disposed in the cavity, to measure a level of the liquid in the cavity; a processor, operably coupled to the liquid level sensor, to poll the liquid level sensor for a measurement of the level of the liquid in the cavity and to estimate a change in the level of the liquid in the cavity based on the measurement of the level of the liquid in the cavity; a visual indicator, operably coupled to the processor and disposed within the cavity to provide a visual indication, prompting a user to drink from the container; and an antenna, operably coupled to the processor to transmit an indication of the change in the level of the liquid in the cavity to a wireless device.

U.S. Pat. No. 10,188,230 requires a visual indicator disposed within the cavity to prompt a user to drink. Thus, the device lights up periodically to remind the person to drink.

U.S. Publication No. 2019/0186979 discloses a liquid level measuring device that includes a Time-of-Flight (TOF) sensor for monitoring the liquid level within a container. A controlling unit collects data in accordance with the measurements of the TOF sensor; and a wireless communication module is utilized to communicate data to a remote computing device.

U.S. Pat. No. 9,151,605 discloses a cap for use with a beverage container. The cap includes a valve activated by hand, and a tilt sensor is located within the housing to estimate the amount of a fluid that flows through the opening when the container is tipped based upon time and the opening size. A display device is provided to display the volume of fluid that is estimated to have been dispensed from the opening.

U.S. Pat. No. 9,151,605 also requires a tilt switch within the housing that activates a timer when the beverage container is tilted in an orientation for drinking.

U.S. Pat. No. 8,378,830 discloses an advanced hydration system in the form of a complete lid which replaces the original lid for the container. A plurality of adaptors are available to modify the new lid to fit a water bottle.

U.S. Pat. No. 8,378,830 requires a plurality of adaptors interchangeable with different containers.

Generally, a wireless container lid having a sensor thereon for measuring liquid volume within the container is known in the art. The sensors used to measure/monitor the liquid volume include optical sensors, time of flight sensors, infrared sensors, or the like. Other restrictive elements, such as a tilt switch, visual indicator, temperature sensor, “cross-talk” prevention, device identifiers, transparent containers, lights, location sensor or the like, are also known.

What is lacking in the art is an adapter ring for converting a standard non-smart water bottle or container into a smart water bottle capable of communicating with electronic devices to assist an individual in maintaining proper hydration. The “smart” wireless container lid having a sealed chamber including the electronics is equipped to measure and indicate liquid volume within a container that is adaptable to fit new or pre-existing containers, wherein a non-smart container can be converted to a smart container. The adapter ring should allow the connection of the original lid including the mouthpiece to provide the same appearance and function of the original container.

### SUMMARY OF THE INVENTION

The present invention is directed to an adapter ring securable to a new or pre-existing water bottle that provides monitoring of the liquid inside of the water bottle and wireless communication to an external electronic device, which may include an algorithm to help the user maintain proper hydration. A bottom portion of the adapter ring includes external or internal helical threads, or the like, adapted to fit onto a threaded portion of the water bottle or container. A top portion of the adapter ring also includes threads, or the like, for connection to the original water bottle top. The adapter ring includes a sealed chamber having a wall separating the liquid flow path from the electronics so that the liquid flow path provides a fluid communication between the top portion and bottom portion of the adapter ring to allow for consumption of the liquid in the container. The sealed chamber includes a time of flight sensor, circuit board, antenna, and a power source, where the time of flight sensor measures and indicates liquid volume within the container for wireless communication to an electronic device such as a smartphone, tablet, computer, etc. The data regarding the liquid consumption may also be sent to a remote location where another person may be monitoring the liquid intake of the user. In some embodiments, the wireless container lid may include an accelerometer or gyroscope for monitoring orientation, position and movement of the liquid container to provide better accuracy of the measurements. An algorithm within the electronic device serves as a reminder and encourages the consumption of water so that the person does not wait until they are already dehydrated to consume water. The remote monitoring ability provides health providers, guardians, parents, or the like, the ability to monitor the liquid intake and thus health of the user. Alerts or the like may be sent to the user or the remote monitor to help the user remain hydrated. This device and system may be used in hospitals, nursing homes, and the like to help nurses monitor patient liquid intake.

Accordingly, it is an objective of the present invention to provide a wireless adapter ring for use on a new or pre-existing open top liquid container such as a water bottle to convert the water bottle into a smart water bottle.

It is a further objective of the present invention to provide an adapter ring that utilizes a time of flight sensor to accurately monitor liquid volume within the container.

It is another objective of the present invention to provide an adapter ring for a water bottle suitable to resolve poor water or liquid consumption habits by providing a measurement and indication of the liquid volume in the container and thus the liquid consumed, wherein the information is wirelessly communicated to an electronic device which keeps the user or a remote person informed.

It is yet another objective of the present invention to provide an adapter ring for a water bottle suitable for measuring and wirelessly reporting liquid remaining, and thus liquid consumed by the user, to a remote person who can monitor and communicate to the user regarding liquid consumption.

It is still yet another objective of the present invention to provide an adapter ring for a water bottle where the circuit board is operably coupled to a time of flight sensor to poll the time of flight sensor to measure liquid volume within the container, and an antenna is operably coupled to the circuit board to transmit the liquid volume measurement data via radio frequency to a separate electronic device.

It is another objective of the present invention to provide a display suitable for indicating the liquid volume measurement data on the outer surface of the adapter ring for direct information communication to the user.

It is yet another objective of the present invention to provide a wireless container lid having a push-button operated visual indicator that is operably connected to the circuit board to give instantaneous information regarding the liquid volume measurement data within the container.

It is still yet another objective of the present invention to provide an adapter ring for a water bottle further including a gyroscope, wherein the gyroscope sensor is used to determine orientation of the lid so that reading of liquid volume is performed when the water bottle is in a neutral or a desired orientation.

Still yet another objective of the present invention is to provide an adapter ring that includes an accelerometer sensor to measure changes in speed or direction of the adapter ring, and thus the water bottle, so that reading of liquid volume is performed after speed or direction of the water bottle is restored to neutral or static.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a side view partially in cross section illustrating the connection between the adapter ring and the water container;

FIG. 2 is a side view partially in cross section illustrating the sealed chamber for the electronics and the liquid flow path;

FIG. 3 is a front view of the adapter ring having an LED readout to indicate fluid level within the container;

FIG. 4 is a top view of the adapter ring illustrating the sealed chamber for the electronics and the liquid flow path;

FIG. 5 is a cross-sectional front view of one embodiment of the adapter ring;

FIG. 6 is a cross-sectional front view of one embodiment of the adapter ring;

FIG. 7 is a cross-sectional front view of one embodiment of the adapter ring;

FIG. 8 is a cross-sectional front view of one embodiment of the adapter ring;

FIG. 9 is a front view illustrating the adapter ring in position on a water bottle;

FIG. 10 is a section view taken along lines 10-10 of FIG. 9 illustrating the adapter ring in cooperation with the water bottle and the bottle lid;

FIG. 11 is a bottom perspective and exploded view illustrating the adapter ring in cooperation with a water bottle having a straw;

FIG. 12 is a bottom perspective and exploded view illustrating the adapter ring in cooperation with a water bottle having a reduced diameter drinking opening and secondary cap;

FIG. 13 is a bottom perspective and exploded view illustrating the adapter ring in cooperation with a water bottle having a secondary cap;

FIG. 14 is a partial bottom perspective and exploded view illustrating the sensor positioning for liquid measurement, and illustrating the threaded connection to the cap portion of the water bottle;

FIG. 15 is a top perspective view illustrating the sealed chamber inside of the adapter ring;

FIG. 16 is a partial enlarged section view taken along lines 10-10 of FIG. 9 illustrating the sealed chamber and the liquid flow path;

FIG. 17 is a partial enlarged section view illustrating the electronics in the sealed chamber;

FIG. 18 is an exploded view of the adapter ring;

FIG. 19 is a top view of the adapter ring;

FIG. 20 is a side view of the adapter ring;

FIG. 21 is a bottom view of the adapter ring;

FIG. 22 is a bottom view of the adapter ring having the splash seal plate removed to illustrate the circuit board and the sensors; and

FIG. 23 is the hydration algorithm of the present device.

### DETAILED DESCRIPTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

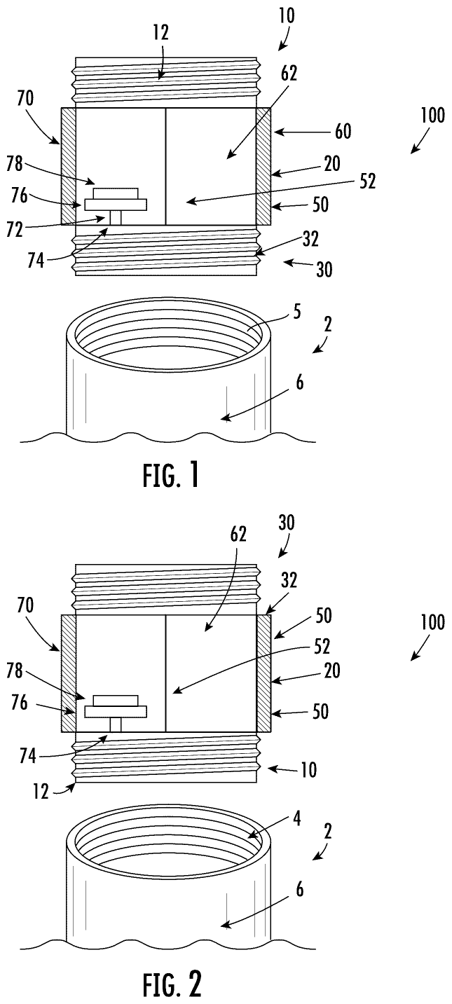

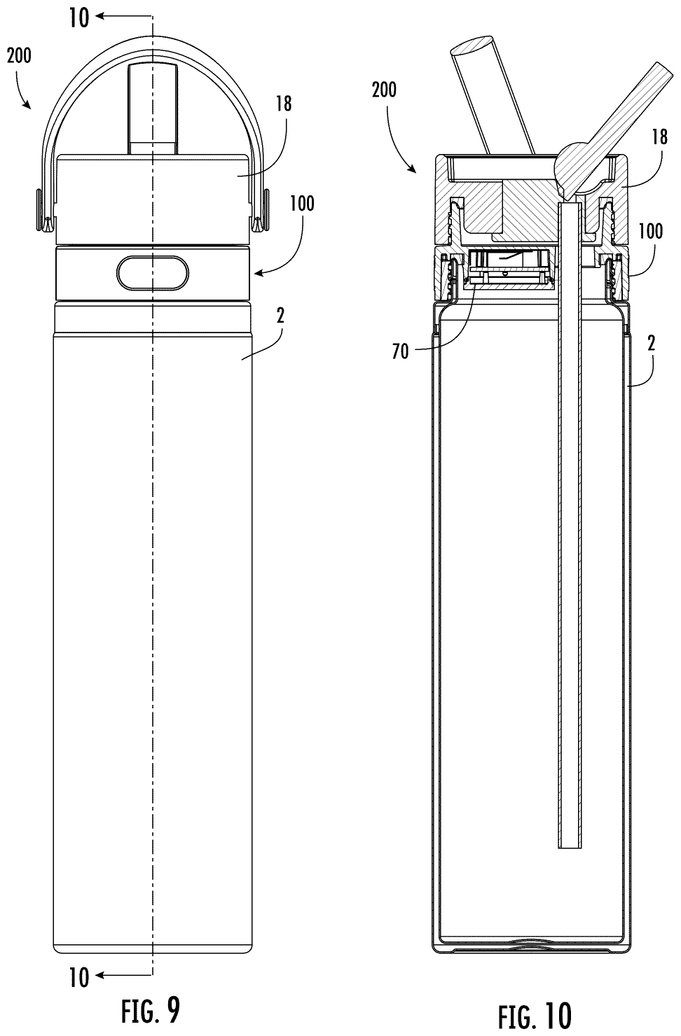

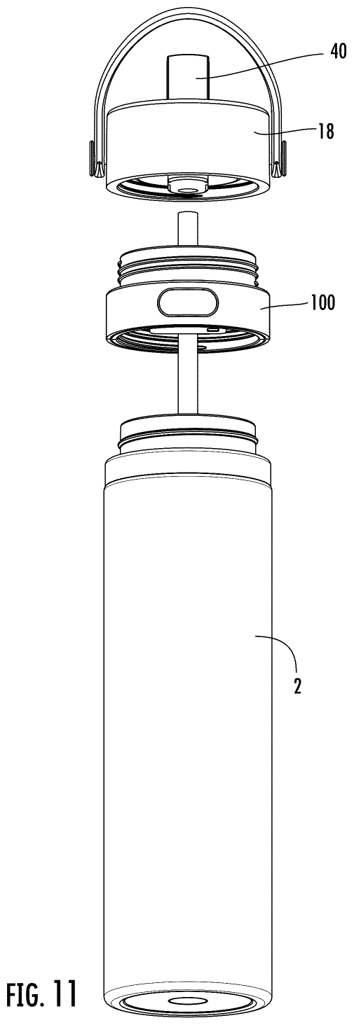

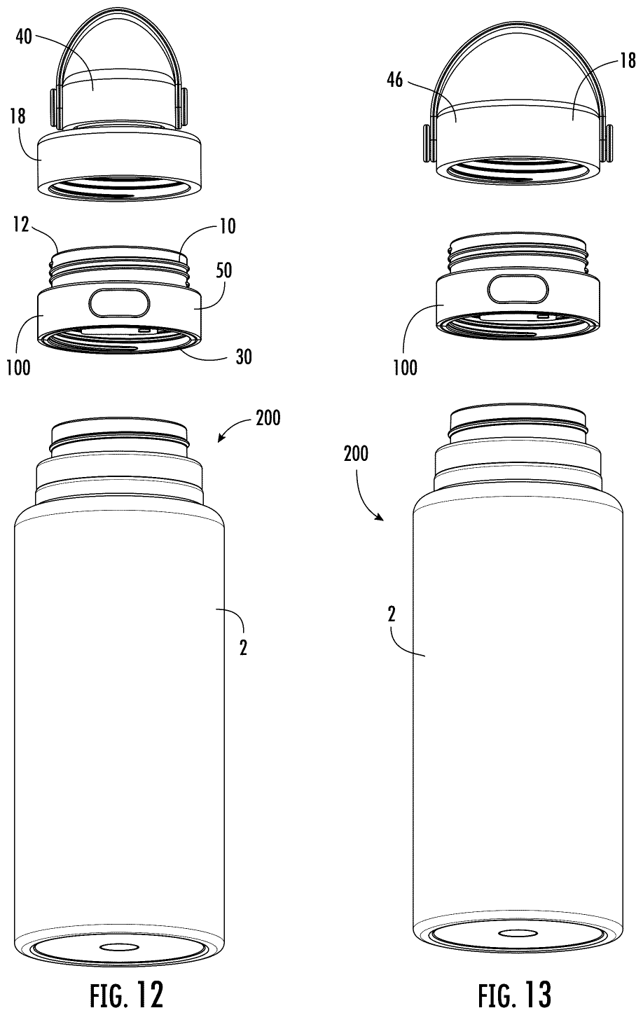

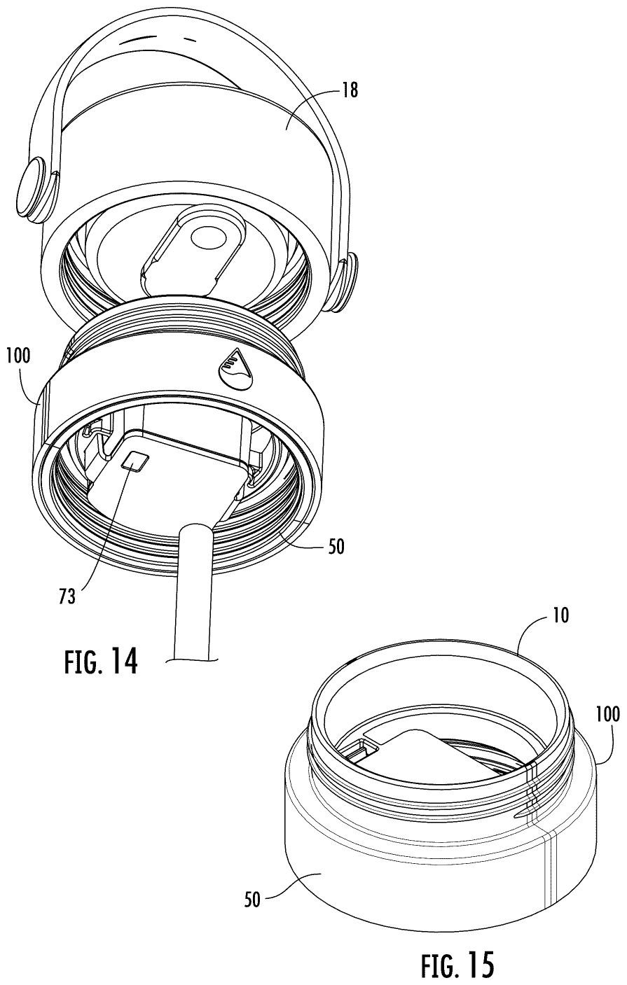

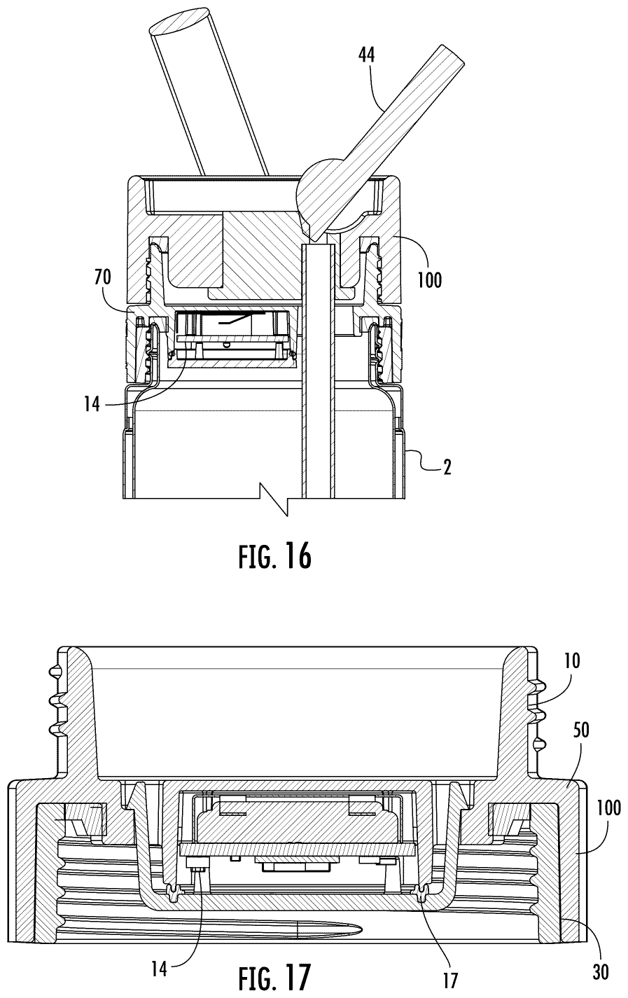

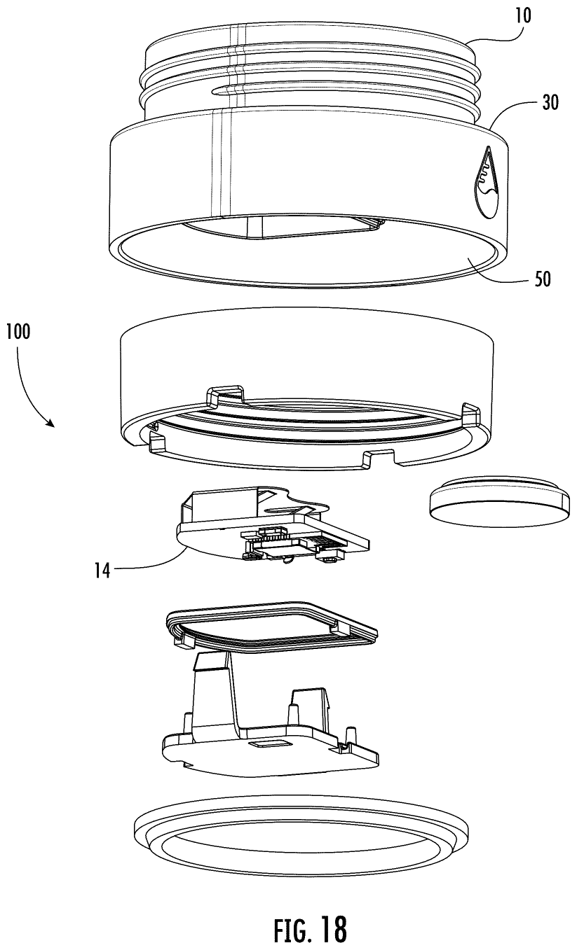

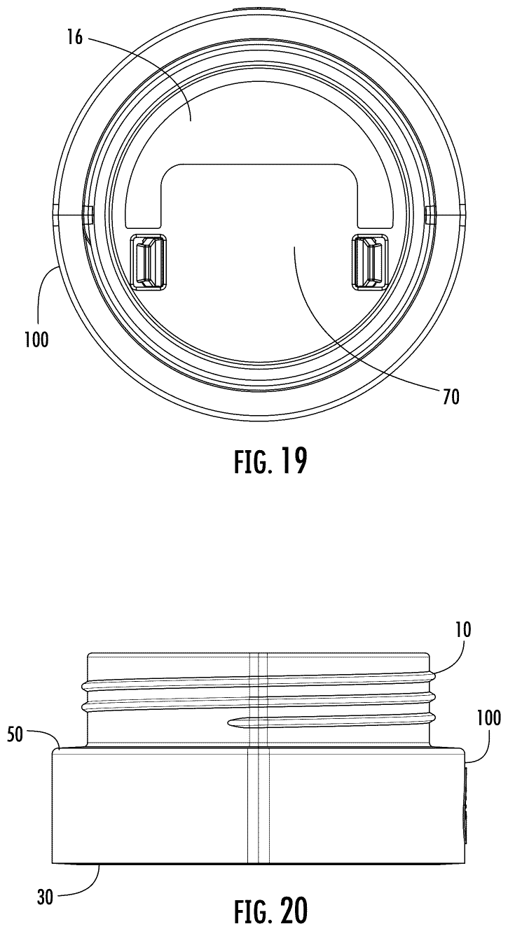

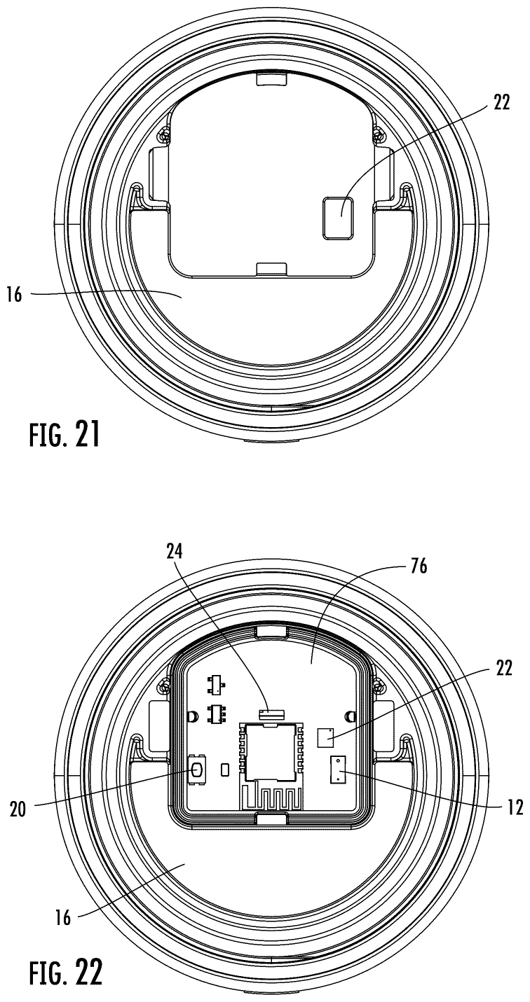

Referring now to FIGS. 1-22, an adapter ring 100 for converting a liquid container 2 into a smart container 200 is illustrated; the adapter ring 100 having a top portion 10 constructed and arranged for connection to a cap assembly 18 from the liquid container 2, a bottom portion 30 constructed and arranged for connection to the liquid container 2, a central portion 50 of the adapter ring 100 containing a sealed chamber 70 having the liquid measuring electronics 14 therein, the central portion 50 also providing a liquid flow path 16 that allows a liquid to pass from the liquid container 2 through the adapter ring 100 when the cap assembly 18 is removed to drink liquids from the liquid container 2, the adapter ring 10 being positioned between the container 2 and the cap assembly 18 when the smart container assembly 200 is closed. In at least one embodiment, the top portion 10 of the adapter ring 100 includes an annular ring 12 which preferably includes helical threads, while a bottom portion 30 also includes a helical thread 32, either of which may be external or internal. It should be noted that while a single lead helical thread is the most preferred for attaching the adapter ring between a container and a cap assembly, the threads may include multiple leads, bayonet mounts and snap lock type connecting surfaces, or simply friction on overlapping surfaces without departing from the scope of the invention. An intermediate portion 50 of the adapter ring 100 includes an annular or tubular shape having a liquid conduit 60 in fluid communication between the top portion 10 and bottom portion 30, and a sealed chamber 70 housing the electronics 14, including a time of flight sensor 72, antenna 74, circuit board(s) 76, and a power source 78, all contained within the outer wall of the intermediate portion 50 and within the sealed chamber. The time of flight sensor 72 includes a time of flight opening 73 or window positioned in a bottom wall of the sealed chamber exposing a surface of the chip to measure liquid volume 6 within the container 2 by directing light, in the form of a modulated light, laser or the like, to the top surface of the liquid and allowing it to reflect back where a phase shift between the modulated light and the reflected light is measured and is calculated to allow the sensor and its associated circuitry to determine where the top surface of the liquid is with respect to the position of the time of flight sensor 72. Once the distance to the top of the liquid is determined, a simple calculation utilizing the inner diameter and height of the container 2 can then be made to determine how much liquid, by volume, remains in the container or how much of the liquid has been consumed. In other embodiments, the adapter ring 100 can further include an accelerometer 22 and/or gyroscope 20. The gyroscope sensor 20 is used to determine orientation of the adapter ring 100 so that a reading of liquid volume is performed after the water container 2 is tipped to an angle for drinking and orientation restored to neutral or vertical. An accelerometer sensor 120 is used to measure changes in speed or direction of the adapter ring 100 so that reading of liquid volume is performed after movement of the container and the container is restored to neutral or static. The data from the time of flight sensor 72 can then be displayed on a visual display 94 positioned on the adapter ring 100 and/or wirelessly communicated to various separate electronic devices via Bluetooth, internet, Zigbee, SIM card or other suitable electronic means for wireless transfer of data; the separate electronic devices having electronics suitable to receive the data transfer and utilize the data for display and/or for calculations utilizing the present algorithm; some of the results of the calculations performed on the data may be returned to the adapter ring 100 for display on the visual display 94. In this manner, the data from the time of flight sensor 72 may be communicated to the user and to medical or other persons as desired. This construction allows the present device to be monitored from remote locations, such as doctor's offices, dieticians, assisted living facilities, and the like, for medical and health reasons. The liquid conduit 60 is separated from the sealed chamber 70 by a wall 52. The wall 52 is preferably sealed in a manner that prevents liquids from the container 2 from contacting the electronics within the sealed chamber 70.

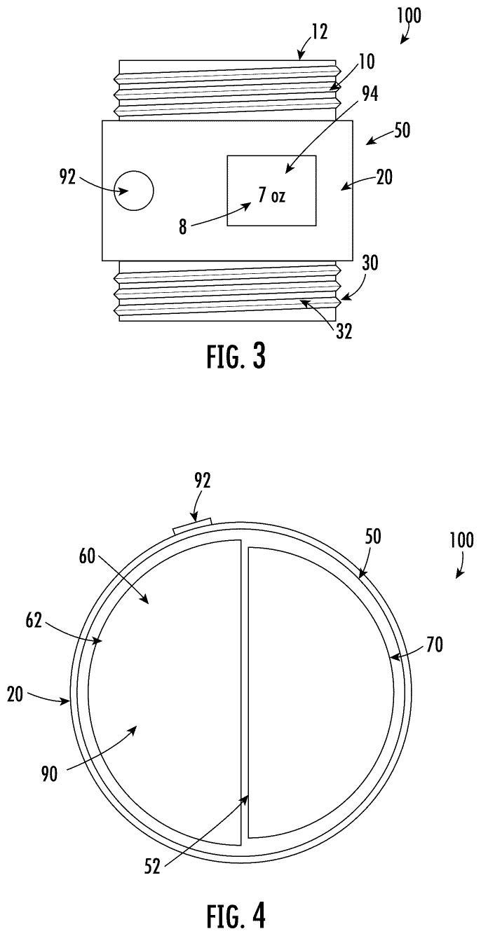

As shown in FIGS. 1-22, on the sealed chamber 70 side of the intermediate portion 50, the circuit board(s) 76 is/are operably coupled to the time of flight sensor 72 to poll the time of flight sensor 72 to measure liquid 6 within the container 2, and the antenna 74 is operably coupled to the circuit board 76 to transmit the liquid measurement volume 8 to a separate electronic device (not shown). The time of flight sensor 72 provides a precise liquid volume measurement and reporting of liquid within the container 2. The circuit board 76 is further operably coupled to a visual display 94 (FIG. 3), such as an LED, LCD display or the like, that visually displays the liquid volume measurement data 8 on the outer surface 21 of the lid 100. The volume measurement data 8 may also include data returned from the separate electronic device after being ran through the algorithm 202 to supply data to the user when not adjacent the separate electronic device. Additionally, a push-button 92 (FIG. 3), which is operably connected to the circuit board 76, provides instantaneous results of the liquid volume measurement data 8 within the container 2 on the visual display 94.

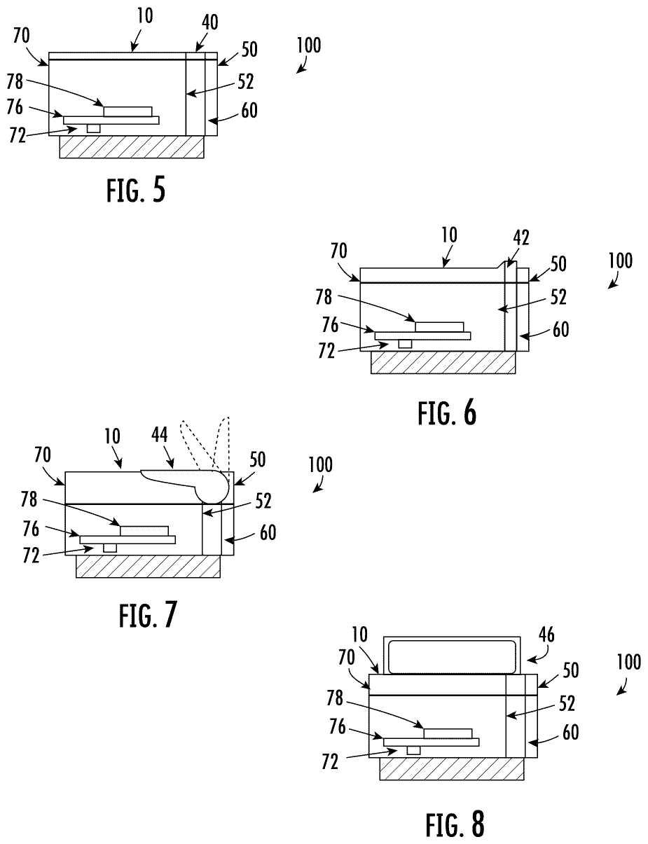

Referring to all the figures, and more specifically to FIGS. 5-8, alternative cap assemblies 18 from the container 2 are illustrated connected to the adapter ring 100. FIG. 5 shows a cap assembly 18 having a hole 40 which aligns with the liquid flow conduit 16 for drinking liquid therethrough. FIG. 6 shows a cap assembly 18 having an elevated spout 42 for drinking liquid therethrough. FIG. 7 shows a cap assembly 18 having a movable straw 44. FIG. 8 shows a cap assembly 18 that includes a threaded cap 46 to enclose the adapter ring 100. As shown in FIGS. 5-7, the intermediate portion 50 includes a liquid conduit 60 in fluid communication between the top portion 10 and bottom portion 30 of the adapter ring 100. The liquid conduit 60 extends to the top portion 10 at the hole 40, elevated spout 42, or movable straw 46.

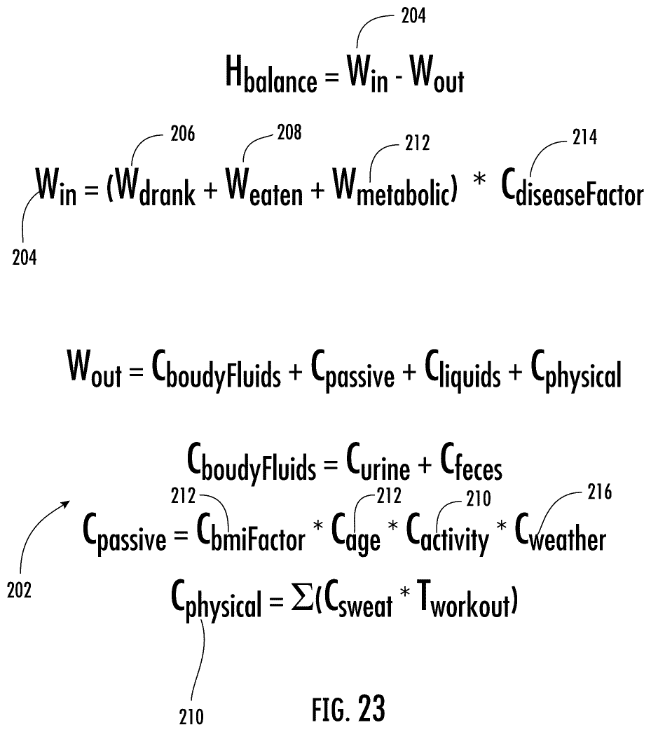

Referring to FIG. 23, the algorithm 202 for estimating hydration is illustrated. The objective of the algorithm 202 is to provide a digestible estimation of a user's hydration level and help them stay hydrated. Input Variables can be either entered manually into the separate electronic device or may be measured automatically through the sensors in the adapter ring 100. Water Intake 204 is calculated based on the time of flight measurements that are received from the adapter ring 100. The total intake is recalculated after every liquid level reading and each time the user sets the bottle down. The ring 100 may also take a liquid level measurement when the cap assembly 18 is removed or the user manually requests a measurement from within the algorithm software. In some embodiments, non-water Intake 206 is also considered in the algorithm 202. Thus, in addition to tracking the amount of liquid consumed, the algorithm 202 can also accept what type of liquid was consumed. Using this data the algorithm 202 will determine how that impacts the user's current hydration level. Food Consumed 208 can also be entered into the algorithm 202. The algorithm 202 can calculate and factor how food intake would effect their hydration level. If the user chooses not to include dietary history, the algorithm 202 will ignore it in its calculation. Fitness Data 210 may also be considered and the separate electronic device may communicate with a fitness tracker, as is known in the art, to retrieve calories burned and workout intensity therefrom. Body Characteristics 212 may also be considered the provided user inputs important body descriptors including height, weight, age and gender into the algorithm software 202. Pre-existing medical issues can also be considered by the algorithm 202. Certain pre-existing medical conditions 214, specifically kidney diseases and the like that require more water to maintain an ideal hydration level, can be accommodated with the algorithm 202. Local Weather Data 216 can also be utilized to help the user maintain proper hydration. High temperature and humidity may cause someone to become dehydrated at a quicker rate. As an output, the algorithm 202 processes the available data and provides an output that includes an estimated volumetric hydration deficit or surplus.

The final equation of the algorithm is:

Hbalance=Win−Wout

Below is the equation that calculates the estimated water intake of a user. Water consumed, as calculated by the adapter ring 100, termed “Wdrank” “Weaten”, is an optional variable that accounts for water in foods that the user ate. The human body naturally generates water; this is accounted for with “Wmetabolic” in the algorithm and is effected by age and gender. “CdiseaseFactor” accounts for how certain medical conditions may affect how a person processes water. Thus, Win=(Wdrank+Weaten+Wmetabolic)*CdiseaseFactor Wout estimates how much water a person expends throughout the day. This portion of the algorithm 202 provides an estimation of multiple calculated values that aim to better define the user. “CbodyFluids” is an estimation of how much water is lost from urine and feces based on age and gender of the user. “Cpassive” accounts for the water a person loses without any additional activity. Liquids other than water dehydrate a person; “Cliquids” accounts for that dehydration. Finally, the last term in the Wout equation is the sum of all different exercise sessions.

Wout=CbodyFluids+Cpassive+Cliquids+Cphysical CbodyFluids=Curine+Cfeces Cpassive=CbmiFactor*Cage*Cactivity*Cweather*Cphysical=Σ(Csweat*Tworkout)

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An adapter ring (100) for converting a liquid container (2) into a smart container (200) comprising:
the adapter ring (100) having a top portion (10) constructed and arranged for connection to a cap assembly (18) from the liquid container (2), a bottom portion (30) constructed and arranged for connection to the liquid container (2), a central portion (50) of the adapter ring (100) containing a sealed chamber (70) having the liquid measuring electronics (14) therein, the central portion (50) also providing a liquid flow conduit (16) that allows a liquid to pass from the liquid container (2) through the adapter ring (100) when the cap assembly (18) is removed to drink liquids from the liquid container (2), the adapter ring (100) being positioned between the container (2) and the cap assembly (18) when the smart container assembly (200) is closed.

2. The adapter ring (100) for converting a liquid container (2) into a smart container (200) as claimed in claim 1, wherein the electronics (14) include a time of flight sensor (72) for measuring the amount of liquid within the liquid container (2).

3. The adapter ring (100) for converting a liquid container (2) into a smart container (200) as claimed in claim 2, wherein the adapter ring (100) includes a visual display (94) for displaying liquid volume measurement data (8).

4. The adapter ring (100) for converting a liquid container (2) into a smart container (200) as claimed in claim 3, wherein the visual display (94) utilizes a plurality of light emitting diodes to form the visual display (94).

5. The adapter ring (100) for converting a liquid container (2) into a smart container (200) as claimed in claim 2 wherein the electronics (14) include an antenna (74), and wherein the electronics (14) are constructed and arranged to generate a radio frequency with respect to the liquid measurement, the radio frequency receivable and the liquid volume data displayable by an electronic device separate from the adapter ring (100).

6. The adapter ring (100) for converting a liquid container (2) into a smart container (200) as claimed in claim 5, wherein the separate electronic device includes a software algorithm (202) for determining the user's hydration level based upon various parameters input into the software algorithm.

7. The adapter ring (100) for converting a liquid container (2) into a smart container (200) as claimed in claim 6, wherein the separate electronic device is constructed and arranged to communicate data from the algorithm (202) to the adapter ring (100) via the radio frequency and the antenna (74) of the electronics (14) receives the data for display on the visual display (94).

8. The adapter ring (100) for converting a liquid container (2) into a smart container (200) as claimed in claim 7, wherein the electronics include a gyroscope (20), the gyroscope is constructed and arranged to monitor the orientation of the adapter ring (100) so that when the adapter ring (100) is rotated to an angle and returned to a vertical position the electronics cause the time of flight sensor (72) to take a liquid level reading within the water bottle (2), wherein the data is sent via the antenna (74) to the separate electronic device for use in the algorithm (202).

9. The adapter ring (100) for converting a liquid container (2) into a smart container (200) as claimed in claim 8, wherein the user's body descriptors including at least height, weight, age and gender are considered in the algorithm (202) to determine the user's hydration level.

10. The adapter ring (100) for converting a liquid container (2) into a smart container (200) as claimed in claim 6, wherein the software algorithm (202) is installed on more than one separate electronic device, and wherein the electronics (14) are constructed and arranged to communicate with all of the separate electronic devices within range of the radio frequency transmission.

11. The adapter ring (100) for converting a liquid container (2) into a smart container (200) as claimed in claim 1 wherein the top portion (10) and the bottom portion (30) include mechanical features for connection to the cap assembly (18) and the liquid container (2).

12. The adapter ring (100) for converting a liquid container (2) into a smart container (200) as claimed in claim 11, wherein the mechanical features are selected from the group consisting of threads, bayonet mounts, snap locks, and friction.

13. The adapter ring (100) for converting a liquid container (2) into a smart container (200) as claimed in claim 1, wherein the liquid flow conduit (16) is constructed and arranged to allow passage of a liquid conduit (60) through the liquid flow conduit (16).

14. The adapter ring (100) for converting a liquid container (2) into a smart container (200) as claimed in claim 7, wherein the electronics include an accelerometer (22), the accelerometer (22) is constructed and arranged to monitor the movement of the adapter ring (100) so that when the adapter ring (100) is moved and returned to a vertical position the electronics (14) cause the time of flight sensor (72) to take a liquid level reading within the water bottle (2), wherein the data (8) is sent via the antenna (74) to the separate electronic device for use in the algorithm (202).

15. The adapter ring (100) for converting a liquid container (2) into a smart container (200) as claimed in claim 5, wherein the electronics (14) include a data transfer system selected from the group consisting of Bluetooth, internet, SIM card and Zigbee.
